(19) United States
(12) Patent Application Publication
(10) Pub. No.: US 2015/0107545 A1
(43) Pub. Date: Apr. 23, 2015

(54) METHOD OF REMANUFACTURING AN ENGINE

(71) Applicant: Caterpillar Inc., Peoria, IL (US)

(72) Inventors: Curtis J. Graham, Peoria, IL (US); Adam W. Ostein, Edelstein, IL (US); Jonathan R. Eggemeyer, East Peoria, IL (US); Donald G. Clark, Iuka, MS (US)

(73) Assignee: Caterpillar Inc., Peoria, IL (US)

(21) Appl. No.: 14/058,497

(22) Filed: Oct. 21, 2013

(51) Int. Cl. F02B 67/00; F02F 7/00; B23P 6/00

(52) U.S. Cl. CPC F02B 67/00; B23P 6/002; F02F 7/0021
USPC 123/195 A; 29/888.011

(57) ABSTRACT

A method of remanufacturing an engine is provided. The method includes drilling a cylinder block to form at least one opening. The method further includes tapping the at least one opening to form screw threads. The method further includes securing a mounting boss to the cylinder block using the screw threads.

### TECHNICAL FIELD

The present disclosure relates to methods of remanufacturing an engine, and more particularly, to methods of re-configuring a cylinder block of the engine.

### BACKGROUND

Many engine manufacturers across the world are continuously devising newer methods of reducing carbon footprint by salvaging used engine components. In some cases, engines manufactured to a first set of specifications may be incidentally compatible to a second set of specifications with partial or substantially minimum modifications, for example, Japanese Publication No. JP2001193474 titled “Auxiliary Machinery Mounting Structure for Engine” discloses a structure for mounting auxiliary machinery, such as a fuel pump and a generator on a cylinder block of an engine.

### SUMMARY

In one aspect of the present disclosure, a method of remanufacturing an engine is provided. The method includes drilling a cylinder block to form at least one opening. The method further includes tapping the opening to form screw threads. The method further includes securing a mounting boss to the cylinder block using the screw threads.

In another aspect, the present disclosure provides a method of remanufacturing an engine. The method includes machining off at least one protrusion defined on a cylinder block of the engine. The method further includes drilling the protrusion to form at least one opening. The method further includes tapping the opening to form screw threads. The method further includes securing a mounting boss to the cylinder block using the screw threads.

In another aspect, the present disclosure provides an engine including a cylinder block, and a mounting boss. The cylinder block includes at least one opening formed on the cylinder block, and screw threads formed within the opening. The mounting boss is secured to the opening on the cylinder block using the screw threads. In one embodiment of the present disclosure, the cylinder block is a cylinder block received after a service life.

Other features and aspects of this disclosure will be apparent from the following description and the accompanying drawings.

### BRIEF DESCRIPTION OF THE DRAWINGS

FIG. 1 is a fragmentary perspective view of an exemplary engine exhibiting a first mounting configuration;

FIG. 2 is a fragmentary perspective view of the engine showing a second mounting configuration with a cylinder block and a mounting boss;

FIG. 3 is a cross-sectional view of the engine of FIG. 2 along plane A-A′;

FIG. 4 is a fragmentary perspective view of the cylinder block of FIG. 1 after machining;

FIG. 5 is a fragmentary perspective view of the cylinder block of FIG. 4 after drilling and tapping;

FIG. 6 is a fragmentary perspective view of the cylinder block of FIG. 5 with the mounting boss seated thereon;

FIG. 7 is a method of remanufacturing the exemplary engine of FIG. 2 in accordance with an embodiment of the present disclosure; and

FIG. 8 is a method of remanufacturing the exemplary engine of FIG. 2 in accordance with another embodiment of the present disclosure.

### DETAILED DESCRIPTION

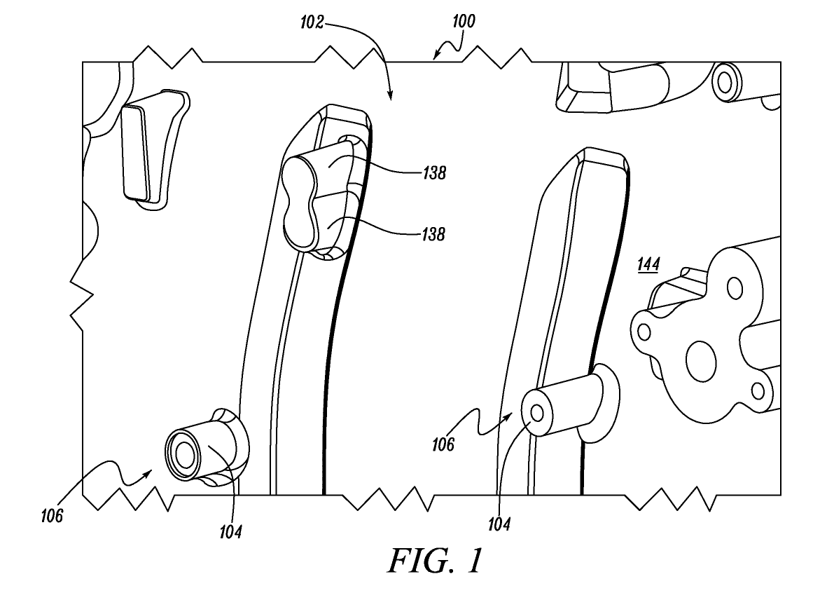

The present disclosure relates to an engine, and more particularly, to a method of remanufacturing the engine. FIG. 1 shows a perspective view of an exemplary engine 100 showing a cylinder block 102 in which disclosed embodiments may be implemented. As shown in FIG. 1, the engine 100 may embody an inline diesel engine. However, in other embodiments, the engine 100 may be, for example, a V-cylinder diesel engine, an inline gasoline engine, or a gas turbine engine.

In one embodiment, the engine 100 may be used to power an off-highway truck (not shown). In various embodiments, the engine 100 may be used to power a motor grader, a landfill compactor, a wheel loader or other types of machines typically used in the construction and automobile industry.

In an embodiment, the cylinder block 102 may be a cylinder block received after a service life. In another embodiment, the cylinder block 102 may have been used in the engine 100 such that the engine 100 may be employed by a first type of machine such as a motor grader (not shown) for a certain period of time before being employed on a second type of machine such as a soil compactor (not shown).

In one exemplary embodiment, the engine 100 may include one or more screw bosses 104 integral with the cylinder block 102. These screw bosses 104 may be used for mounting the cylinder block 102 onto the first type of machine. The screw bosses 104 may together represent a first mounting configuration 106 on the cylinder block 102 and therefore, the cylinder block 102 may be construed to have the first mounting configuration 106 defined thereon.

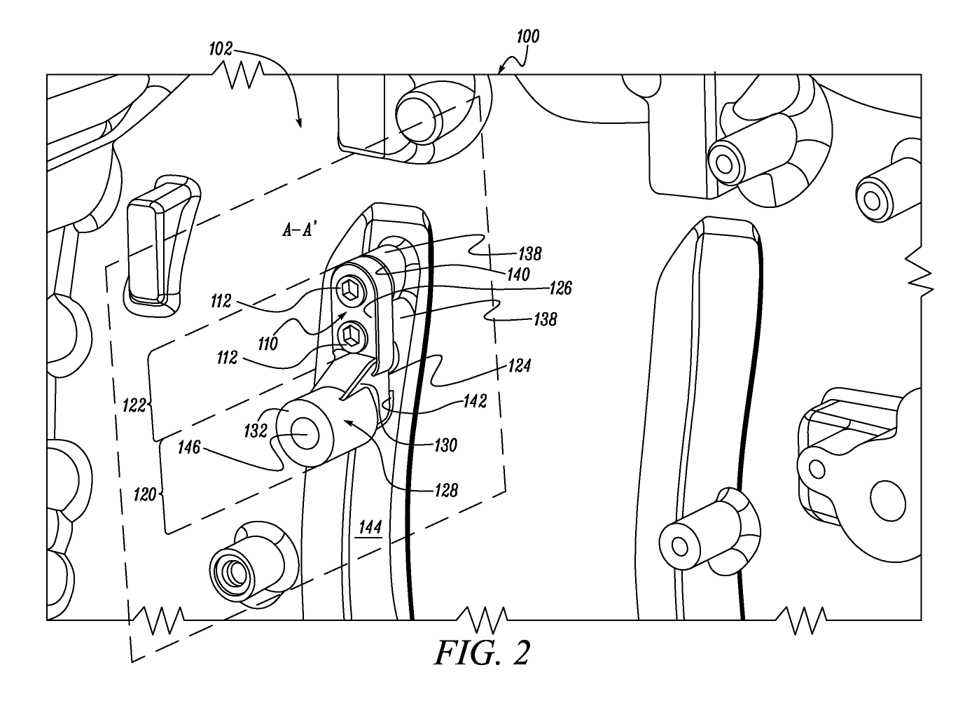

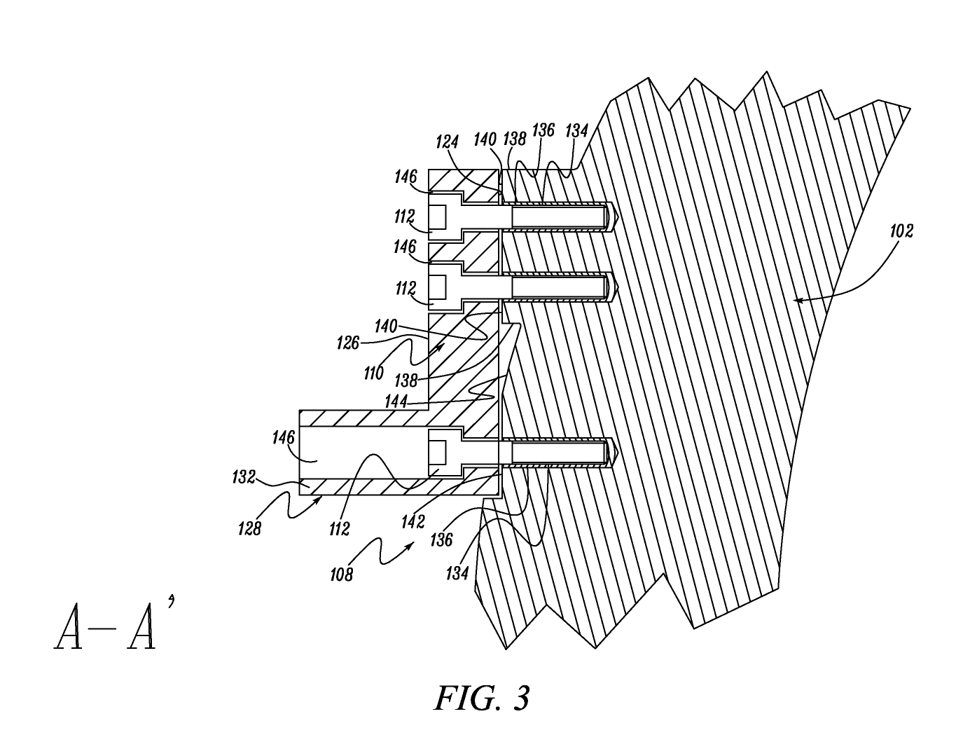

With reference to the preceding embodiment, the cylinder block 102 having the first mounting configuration 106 may be configured to have a second mounting configuration 108 (as shown in FIGS. 2 and 3). The first mounting configuration 106 defined on the cylinder block 102 may be replaced by a second mounting configuration 108 in order to make the cylinder block 102 compatible for use on the second type of machine. Explanation pertaining to the steps of configuring the cylinder block 102 with the second mounting configuration 108 will be made with reference to FIGS. 2-6.

FIG. 2 shows a fragmentary perspective view of the engine 100 with the second mounting configuration 108. The engine 100 further includes a mounting boss 110 secured to the cylinder block 102 using one or more fasteners 112 (two fasteners shown in FIG. 2) such that the mounting boss 110 may be used to mount the engine 100 onto the second type of machine.

The mounting boss 110 may include an elongated body 114 having a first end 116 and a second end 118 and defining a first portion 120 and a second portion 122 therebetween. The mounting boss 110 may further include a base 124 and an opposing upper face 126. The mounting boss 110 may further include a receptacle member 128 located on the first portion 120. The receptacle member 128 may axially extend from the upper face 126 of the elongated body 114. Further, the mounting boss 110 may be provided with a support member 130 angularly extending from a sidewall 132 of the receptacle member 128 to the upper face 126 of the elongated body 114. The support member 130 may be configured to provide rigidity and strength in supporting the receptacle member 128 on the elongated body 114.

Although a specific type and shape of the mounting boss 110 is shown and described herein, the type and shape of the mounting boss 110 is merely exemplary in nature. Any suitable shape may be used to form the mounting boss 110 such that the mounting receptacle member 128, when secured to the cylinder block 102, may allow the engine 100 to be mounted on the second type of machine.

FIG. 3 shows a cross-section of the engine 100 of FIG. 2 along plane A-A′. The cylinder block 102 with the second mounting configuration 108, as disclosed herein, includes at least one opening 134 formed on the cylinder block 102, and screw threads 136 formed within the opening 134. For purposes of illustration, three openings 134, and screw threads 136 within the three openings 134 of the cylinder block 102 are shown in FIG. 3. The mounting boss 110 is secured to the openings 134 on the cylinder block 102 using the screw threads 136.

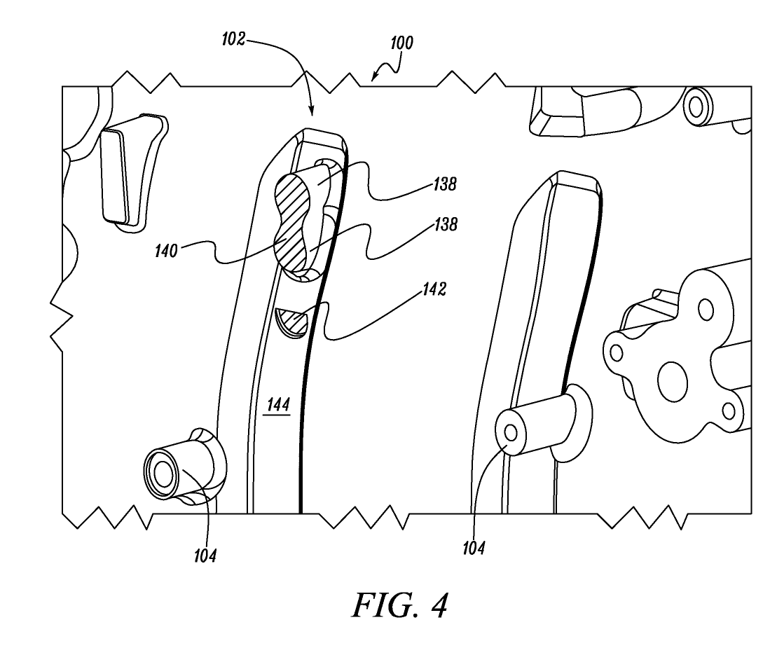

As shown in FIGS. 1-4, the cylinder block 102 of the exemplary engine 100 may include a protrusion 138 defined thereon. For purposes of illustration, two protrusions 138 are shown on the cylinder block 102 of FIGS. 1-6. However, any number of protrusions 138 may be defined on the cylinder block 102 based on the type of the cylinder block used. Referring to FIGS. 1 and 4, the protrusions 138 (as shown in FIG. 1) may be machined to expose a surface 140 of the protrusion 138 (as shown in FIG. 4).

As shown in FIG. 4, the cylinder block 102 may include a surface portion 142 defined thereon. The surface 140 and the surface portion 142, disclosed herein, may be formed by machining off the protrusions 138 and an outer surface 144 of the cylinder block 102 respectively using commonly known machining processes such as milling, turning, cutting, or facing operation.

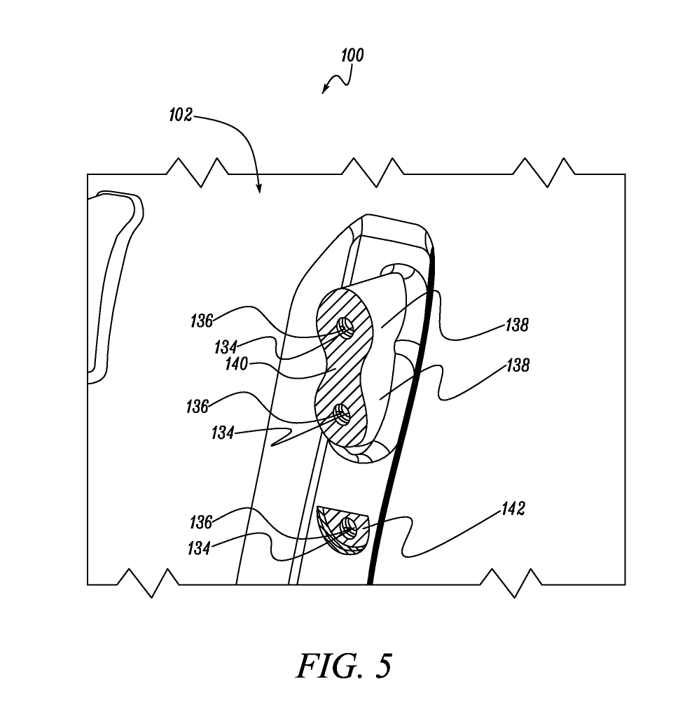

As shown in FIGS. 3 and 5, the openings 134 may be formed on the surface 140 of the protrusions 138. One of the openings 134 may be formed on the surface portion 142 of the cylinder block 102. The openings 134, disclosed herein, may be formed using commonly known manufacturing processes such as drilling and/ or counter boring operation.

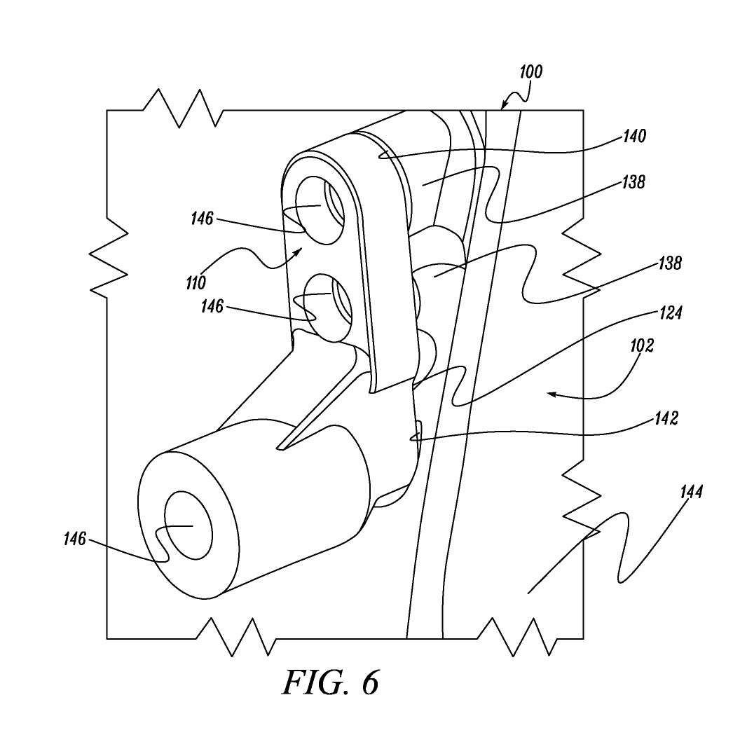

Referring to FIGS. 3 and 6, the surface 140 of the protrusions 138 and the surface portion 142 on the cylinder block 102 may be formed such that the base 124 of the mounting boss 110 may be flush with the surface 140 and the surface portion 142. Further, the openings 134 formed on the surface 140 of the protrusions 138 and the surface portion 142 on the cylinder block 102 may be configured to be coaxial with openings 146 defined on the mounting boss 110.

As shown in FIGS. 3 and 5, screw threads 136 may be formed within the openings 134 of the cylinder block 102. Referring to FIGS. 2 and 3, the mounting boss 110 is secured to the openings 134 on the cylinder block 102 using the screw threads 136. The fasteners 112 may secure the mounting boss 110 to the cylinder block 102. The fasteners 112 may be inserted within the openings 146 of the mounting boss 110 and engaged with the screw threads 136 within the openings 134 of the cylinder block 102. The fasteners 112 may be torque wrenched into the screw threads 136, and secured using LOCTITIE®, epoxies, or other adhesives such as cyanoacrylate. In this manner, the cylinder block 102 may be configured to include the second mounting configuration 108.

In various embodiments of the present disclosure, the fasteners 112 may be selected from at least one of set screws, hex bolts, grub screws, and Allen bolts. Although set screws, hex bolts, grub screws, and Allen bolts are disclosed herein, it is to be noted that any type of fasteners commonly known in the art may be used to accomplish the securement of the mounting boss 110 to the cylinder block 102.

### INDUSTRIAL APPLICABILITY

Many engine manufacturers across the world are continuously devising newer and newer methods of reducing carbon footprint by salvaging used engine components. In some cases, engines manufactured to a first set of specifications may be incidentally compatible to a second set of specifications with partial or minimal modifications.

While numerous strategies may be employed to salvage the engine components, a number of components to be salvaged therein may determine an economic factor of the salvaging process. It is commonly believed that while salvaging an engine, the lesser the number of components requiring modifications, re-modeling, the more quick, cost-effective and easy is the re-manufacturing and salvaging process.

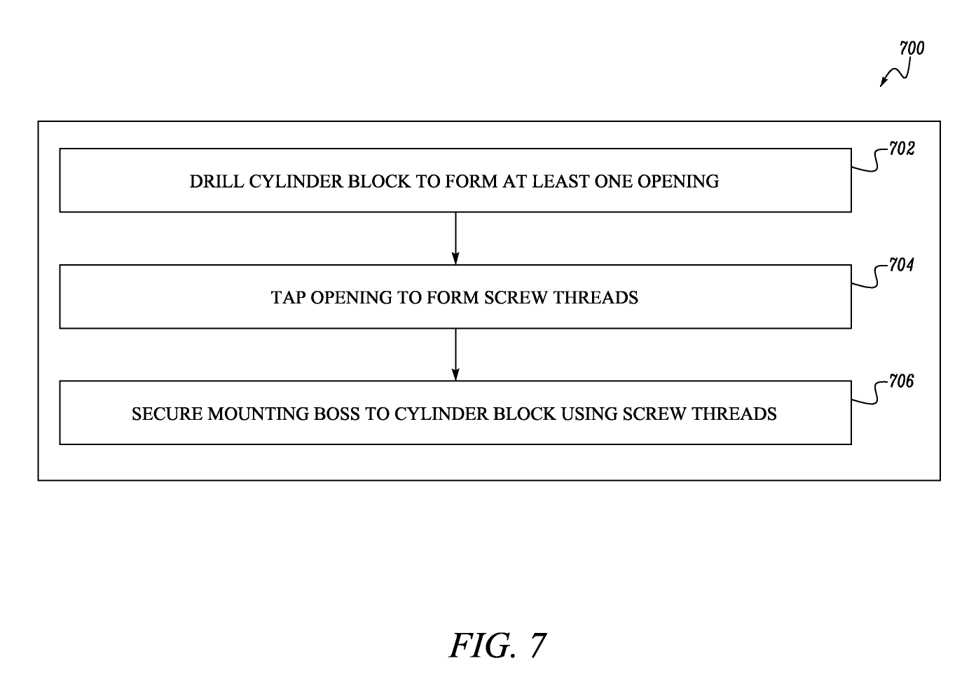

FIG. 7 is a method 700 of remanufacturing the exemplary engine 100 of FIG. 2. With implementation of the method 700, the second mounting configuration 108 (as shown in FIGS. 2 and 3) may replace the first mounting configuration 106 on the cylinder block 102 (as shown in FIG. 1) such that the engine 100 may be compatible for use with the second type of machine.

Although, it is disclosed herein that the second mounting configuration 108 may replace the first mounting configuration 106 on the cylinder block 102 for the purposes of mounting the engine 100 onto the second type of machine, it is to be noted that the first mounting configuration 106 may continue to exist on the cylinder block 102 of the engine 100. Therefore, the cylinder block 102 may include the first mounting configuration 106 together with the second mounting configuration 108 thereby making the engine 100 compatible for fitment and use on both the first and the second types of machines after the second mounting configuration 108 is incorporated into the engine 100. Therefore, in various embodiments of the present disclosure, it may be possible to envision and include both the first and the second mounting configurations 106, 108 on the cylinder block 102 such that the engine 100 is rendered compatible for fitment and use on both the first and the second types of machines.

At step 702, the method 700 includes drilling the cylinder block 102 to form the at least one opening 134. In an embodiment, the method 700 further includes machining the cylinder block 102 before drilling the cylinder block 102 such that the cylinder block 102 defines the surface portion 142 thereon. The surface portion 142 may mate with the base 124 of the mounting boss 110 and allow the base 124 of the mounting boss 110 to be flush with the surface portion 142.

Further, the method 700 includes drilling the surface portion 142 of the cylinder block 102 such that the opening 134 on the surface portion 142 is configured to be coaxial with one of the openings 146 on the mounting boss 110. The drilling disclosed herein may be accomplished by using commonly known tools in the art such as but not limited to a drill bit and powered drilling machine (not shown).

At step 704, the method 700 further includes tapping the openings 134 to form the screw threads 136. As commonly known in the art, tapping is a manufacturing operation to form internal screw threads within an opening. The tapping of the openings 134 disclosed herein may be accomplished using a tap-tool.

At step 706, the method 700 further includes securing the mounting boss 110 to the cylinder block 102 using the screw threads 136. The securement of the mounting boss 110 to the cylinder block 102 may be accomplished by inserting the fasteners 112 within the openings 146 of the mounting boss 110 and engaged with the screw threads 136 within the openings 134 of the cylinder block 102. The fasteners 112 may be selected from at least one of set screws, hex bolts, grub screws, and Allen bolts.

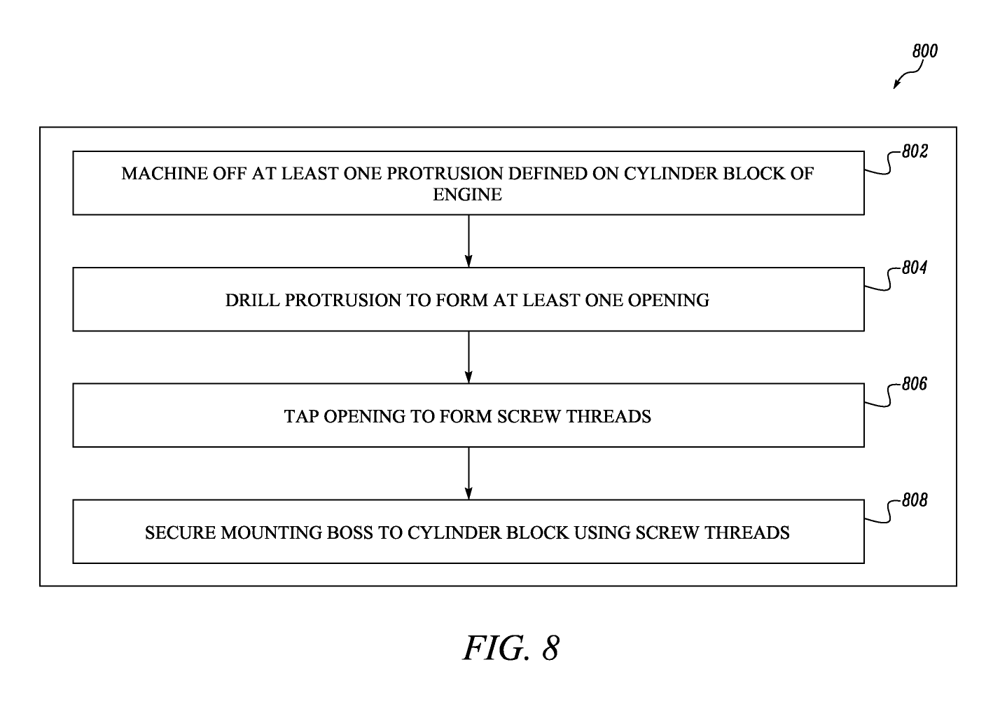

FIG. 8 is a method 800 of remanufacturing the exemplary engine 100 of FIG. 2. With implementation of the method 800, the second mounting configuration 108 (as shown in FIGS. 2 and 3) may replace the first mounting configuration 106 on the cylinder block 102 (as shown in FIG. 1) such that the engine 100 may be compatible for use with the second type of machine.

At step 802, the method 800 includes machining off the protrusions 138 defined on the cylinder block 102 of the engine 100. Machining off the protrusions 138 may allow the base 124 of the mounting boss 110 to be disposed flush with the protrusions 138.

At step 804, the method 800 further includes drilling the protrusions 138 to form the openings 134. The openings 134 on the protrusions 138 of the cylinder block 102 are configured to be coaxial with the openings 146 on the mounting boss 110.

At step 806, the method 800 further includes tapping the openings 134 to form the screw threads 136. At step 808, the method 800 further includes securing the mounting boss 110 to the cylinder block 102 using the screw threads 136. In an embodiment, the step 808 of securing the mounting boss 110 to the cylinder block 102 includes inserting the fasteners 112 into the openings 146 and engaging the fasteners 112 to the screw threads 136 on the openings 134 of the cylinder block 102. The fasteners 112 may be set screws, hex bolts, grub screws, or Allen bolts.

With use of the methods 700 or 800 disclosed herein, the first mounting configuration 106 on the cylinder block 102 of the engine 100 may be replaced with the second mounting configuration 108. The methods 700 or 800 may accomplish re-manufacturing of the engine 100 using simple manufacturing processes. Further, the mounting boss 110 disclosed herein, may be secured to the cylinder block 102 using the fasteners 112 and the screw threads 136. Thereafter, the engine 100 may be employed on the second type of machine with ease.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

What is claimed is:

1. A method of remanufacturing an engine, comprising:
drilling a cylinder block to form at least one opening;
tapping the at least one opening to form screw threads; and
securing a mounting boss to the cylinder block using the screw threads.

2. The method of claim 1 further comprising:
machining the cylinder block to form at least one surface portion therein such that a base of the mounting boss is flush with the surface portion of the cylinder block.

3. The method of claim 2, wherein drilling the cylinder block to form the at least one opening includes drilling the surface portion of the cylinder block such that the at least one opening on the surface portion is configured to be coaxial with an opening on the mounting boss.

4. The method of claim 1, wherein securing the mounting boss to the cylinder block using the screw threads on the cylinder block includes fastening the mounting boss to the cylinder block using a fastener.

5. A method of remanufacturing an engine, comprising:
machining off at least one protrusion defined on a cylinder block of the engine;
drilling the at least one protrusion to form at least one opening;
tapping the at least one opening to form screw threads; and
securing a mounting boss to the cylinder block using the screw threads.

6. The method of claim 5, wherein machining off at least one protrusion comprises machining off the protrusion such that a base of the mounting boss is flush with a surface of the protrusion.

7. The method of claim 5, wherein drilling the at least one protrusion to form the at least one opening includes drilling the at least one protrusion such that the at least one opening on the at least one protrusion is configured to be coaxial with an opening on the mounting boss.

8. The method of claim 5, wherein securing the mounting boss to the cylinder block using the screw threads on the cylinder block includes fastening the mounting boss to the cylinder block using a fastener.

9. An engine comprising:
a cylinder block comprising:
an opening formed on the cylinder block; and
screw threads formed within the opening; and
a mounting boss secured to the opening on the cylinder block using the screw threads.

10. The engine of claim 9, wherein the cylinder block is a cylinder block received after a service life.

11. The engine of claim 9, wherein the cylinder block includes a surface portion that mates with the mounting boss.

12. The engine of claim 11, wherein the opening is formed on the surface portion of the cylinder block.

13. The engine of claim 9, wherein the cylinder block comprises a protrusion defined thereon.

14. The engine of claim 13, wherein a base of the mounting boss contacts a surface of the protrusion.

15. The engine of claim 14, wherein the at least one opening is formed on the surface of the protrusion.

16. The engine of claim 15, wherein the screw threads are formed within the opening formed in the protrusion.

17. The engine of claim 15, wherein the opening formed in the protrusion is configured to be coaxial with at least one opening defined on the mounting boss.

18. The engine of claim 9 wherein the mounting boss is secured to the cylinder block by a fastener engaging the screw threads in the opening on the cylinder block.

19. The engine of claim 18, wherein the fastener is selected from at least one of set screws, hex bolts, grub screws, and Allen bolts.
